(19) United States
(12) Patent Application Publication
(10) Pub. No.: US 2004/0229645 A1
(43) Pub. Date: Nov. 18, 2004

(54) Cellular phone and writing instrument in combination

(76) Inventor: Robert D. Montgomery, Reno, NV (US)

Correspondence Address: Robert D. Montgomery, 1685 West 12th Street, Reno, NV, 89503, US

(21) Appl. No.: 10/438,085

(22) Filed: May 14, 2003

(51) Int. Cl. H04M 1/00

(52) U.S. Cl. 455/556.1; 455/574

(57) ABSTRACT

A functioning cell phone having internal electrical components that are housed within a writing instrument, such as within an ink pen or pencil, each of which are fully functional for writing therewith. Thus this combination provides unusual novel results and the cell phone includes numerous optional features as taught herein.

### FIELD OF THE INVENTION

This invention relates to cell phones in general but more particularly pertains to a cell phone and its associated electrical components being housed within a writing instrument, such as a pen or pencil. The writing instrument is functional, refillable and/or ergonomically designed for writing. Also, the cell phone may be voice activated, it may include voice recognition and other optional performance features, such as a simplified keyboard, an antenna, vibration actuator, indicator light, and a data viewing screen for display of messages, etc.

### BACKGROUND OF THE INVENTION

In today's society cell phones and other communication devices have become extremely popular, especially with executives and the like. Cell phones in general have made major design advances within the recent years and with today's electronics such devices are being improved almost on a daily basis. For example, the first cell phones were extremely bulky, large, included complicated electronics, etc. However, today's cell phones are very small, compact, include simplified electronics, and they are much more efficient. Also, optional features have been included depending on the consumer needs. For example, some options include voice activation, voice recognition, vibration devices which vibrate the cell phone when a call is received, etc.

Although major advancements have been incorporated within cell phones, there is still a need for further improvements which have not yet been recognized, addressed, or resolved. For example, most cell phones still incorporate the typical standard type keypad. Namely, numerous buttons for entering data, each of which are normally arranged in three rows and each button being used for entering only one numeral, respectively. This keypad design is somewhat functional but it necessitates that the keypad be rather large so as to accommodate room for ones fingers to actuate the buttons. Thus, most cell phones and the like are still somewhat of an inconvenience due to this keypad design. Still further, most cell phones are only functional for communication purposes and they do not include any additional features non related to communication.

Therefore the present invention is novel as it not only provides a new and improved cell phone having a unique keypad design, but the cell phone and its associated electrical components are contained within a housing, with the housing being substantially of a shape and size comparable to a writing implement. Thus, the present cell phone is disguised as a pen or pencil, respectively. This is very advantageous as most users also carry a writing instrument so it would be desirable to combine both a cell phone and writing instrument within one portable, compact housing which is also functional for writing as well.

### SUMMARY OF THE INVENTION

It is therefore an object of the present invention to provide a cell phone and writing instrument in combination, both of which are fully functional and easy to use.

It is another object of the present invention to provide a cell phone and writing instrument in combination that is portable, compact, attractive, and aesthetically pleasing to the eye.

Yet another object of the present invention is to provide a cell phone and writing instrument in combination which can be produced with multiple optional features depending on consumer and engineering choice. For example, it may include voice recognition and/or voice activation for personalized use, it may include an on/off switch that automatically lights up or flashes when receiving an incoming call. It may include a vibration device so as to vibrate the housing when receiving an incoming call. These are just some of the optional features and other will be addressed within the forthcoming specification and drawings.

Still another object of the present invention is to provide a cell phone and writing instrument in combination wherein the writing stylus may be either in the form of a refillable ink pen, or a pencil receptacle that is refillable with a led insert.

Yet another object of the present invention is to provide a cell phone and writing instrument in combination that includes a data viewing screen for display of messages and/or numbers there through. For promotional reasons, the window may also be used for display of advertisements or the like. Thus, a user may wish to know the current sales at a particular department store and they can easily immediately view the desired info on the spot. Or the data viewing screen may continuously display advertisements for different members when they pay a fee to join this special program. This special use may also employ sounds pertaining to the advertisement on display. Still further the data viewing screen may be used for display of a picture such as for viewing of the person calling, voice messages or even receiving e-mail, etc.

Another object of the present invention may be to provide a cell phone and writing instrument in combination that is specifically designed for use by handicapped individuals. For example, the entire unit may be made for a blind person, wherein the instructions and/or buttons are in Braille. Thus when the phone vibrates upon receiving an incoming call, the user can then answer it and reply via voice. If the person is deaf, the unit may be produced so as to allow for visual communications only, such as when a call is incoming the unit vibrates and displays a message on the data viewing screen and the user then responds by entering a reply message via buttons.

Yet a very important object of the present invention is to provide a cell phone and writing instrument in combination that includes a unique keypad that employs two-position buttons so as to eliminate the need for additional buttons. For example, in one embodiment the unit is fully functional with only five two-position switches or buttons. However, it is to be noted the unit can be produced with a choice of many different types of buttons, touch activated switches, or even a joystick, etc.

It is another important object of the present invention to provide a cell phone and writing instrument in combination each of which are housed within an ergonomically friendly design.

Still another object of the present invention is to provide a cell phone and writing instrument in combination that will allow for the user to write a phone number or message, and this resultant movement will be automatically recognized and recorded for future use.

Yet another object of the present invention is to provide a cell phone and writing instrument in combination that may further include an electric stylus and storage compartment therefore, such as those types of stylus's associated with computers or palm pilots, etc. thus if so desired the unit may function as a wireless mouse, or the like.

Another very important object of the present invention is to provide a cell phone and writing instrument in combination which may be activated via a wireless system including a receiver that is disguised within a different object, such as within an earring or within the frame for eyeglasses, or the like.

Other objects and advantages will become apparent when taken into consideration with the following specifications and drawings.

### BRIEF DESCRIPTION OF THE DRAWINGS

FIG. 1 is substantially a perspective overview of the preferred embodiment for the present invention.

FIG. 2 is substantially a top view depicting one embodiment for the on/off switch mechanism, light and clicker in combination.

FIG. 3 is substantially a perspective overview of a second embodiment for the present invention.

### DETAILED DESCRIPTION OF THE DRAWINGS

Referring now in detail to the drawings wherein like characters refer to like elements throughout the various views. Depicted in FIG. 1, (10) is substantially an overview for the preferred embodiment for the cell phone and writing instrument in combination of the present invention, comprising of the following.

A housing (12) that is of a shape and size comparable to a writing implement, respectively, such as in the form of an ink pen or pencil. Housing (12) can be made from any suitable material of engineering choice, such as plastic or the like. Housing (12) also may be transparent, or decorated, or include indicia thereon for aesthetic purposes if so desired.

Housing (12) having a top end (12-A), a bottom end (12-B), an elongated body section (12-C) and an internal compartment (14) for containment of cell phone electrical components (16) and a writing stylus (18) therein, with the writing stylus (18) protruding from bottom end (12-B) when in a writing mode.

It is to be understood the actual cell phone electrical components (16) are not taught herein as such technology is very well known within the art, and all of the electrical components currently exist so there is no reason to include their teachings or functions herein. Thus, the noted electrical components (16) are only partially shown for clarity purposes. However, it is to be understood that all of the noted components typically found within the newer cell phones are inherent herein, such as multiple circuit boards, a rechargeable battery, switches, chips, wiring, etc.

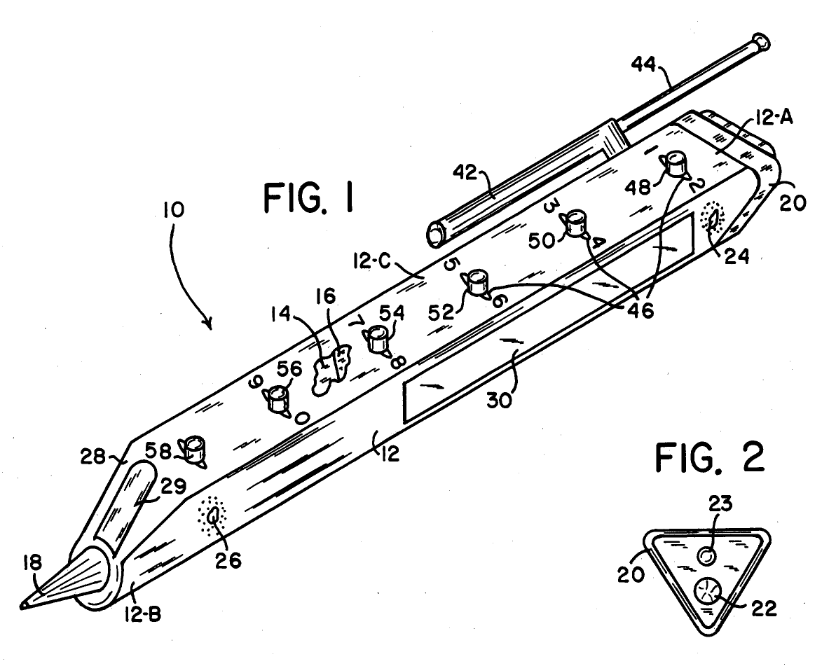

Top end (12-A) may include an on/off switch mechanism (20) that is more clearly depicted in FIG. 2. It is to be noted any suitable type of on/off switch mechanism may be incorporated depending on engineering choice. Thus, the mechanism as depicted herein is only exemplary of one possible embodiment. As depicted herein, on/off switch mechanism (20) is of the push-button type and further includes a light (22) and pen clicker (23). Whereby, light (22) illuminates and/or flashes when the cell phone receives an incoming call. Thus the light (22) visually notifies the user that a call is being received and if they wish to answer the call they simply press the switch mechanism (20) that automatically activates to turn on the cell phone and allow the user to verbally interact with the caller. Thereafter, the user simply presses on/off switch mechanism (20) to end the call.

It is to be noted, housing (12) may include a standard type of speaker (24) which allows the user to listen and hear the caller there through, and a standard receiver (26) which allows the user to speak there through, such as found on any typical conventional phone or portable cell phone. However, with today's advancements in electronics the need for this standard type of speaker and receiver can be eliminated, as taught and addressed within current prior art.

Referring again to FIG. 1, as depicted therein bottom end (12-B) of housing (12) further provides an angled cutout section (28) so as to allow a user to visually see writing stylus (18) while writing. This not only provides for visual aid but also provides the user with a feeling of normalcy and comfort similar to the feeling of a conventional ink pen or pencil. As an additional feature angled cutout section may include a transparent cover (29) and if so desired an internal light located therein (not shown for clarity purposes) with the light being operable by a switch mechanism controlled by a suitable button.

Housing (12) further includes a fixedly attached pen clip (42) which functions in the same manner as a typical pen clip, and allows the user to attach the housing (12) onto an object of choice, such as onto their pocket or the like. However, the pen clip (42) further functions as an antenna which is most advantageous. If so desired, pen clip (42) may further include a telescopic antenna (44) therein. This is most functional for use in troublesome cell phone receiving areas, as it helps to increase clarity and reception.

Further depicted in FIG. 1, housing (12) includes a data viewing screen (30) for display of messages and/or numbers there through. As previously noted this data viewing screen may also be used for advertising purposes, or the like if so desired. Within this embodiment, and as previously noted the writing stylus (18) may be of any suitable type depending on engineering choice. For example, the writing stylus (18) may be in the form of an ink pen, or a pencil, etc., and it is to be understood that each may be replaceable and/or refillable.

Further depicted in FIG. 1, the cell phone and writing instrument (10) includes use of buttons. It is to be noted substantially any type of buttons may be used according to engineering choice, thus the following is only exemplary of one possible configuration for the buttons. Wherein, elongated body section (12-C) includes multiple activation buttons (46) thereon and each of the buttons (46) protrude outwardly from within elongated body section (12-C). Furthermore, multiple activation buttons (46) are each of the two-position type, if so desired. Whereby, in this embodiment multiple activation buttons (46) number at least five including a first button (48), a second button (50), a third button (52), a fourth button (54) and a fifth button (56). The first button (48) when activated by pushing the button into a first or second position registers either numeral (1) or (2). The second button (50) when activated by pushing the button into a first or second position registers either numeral (3) or (4). The third button (52) when activated by pushing the button into a first or second position registers either numeral (5) or (6). The fourth button (54) when activated by pushing the button into a first or second position registers either numeral (7) or (8) and the fifth button (56) when activated by pushing the button into a first or second position registers either numeral (9) or (0). Whereby, all of the numerals between 1 and 10 can be easily registered by using only five buttons, which is very space saving and advantageous. If so desired however, the device may include at least one additional button (58) which when activated does not register a numeral but initiates a programmable response, depending on engineering choice. For example, one possible programmable response would be to include automatic activation for recording numerals and/or messages when writing with the writing stylus (18). Again such technology currently exists so the particulars are not addressed herein.

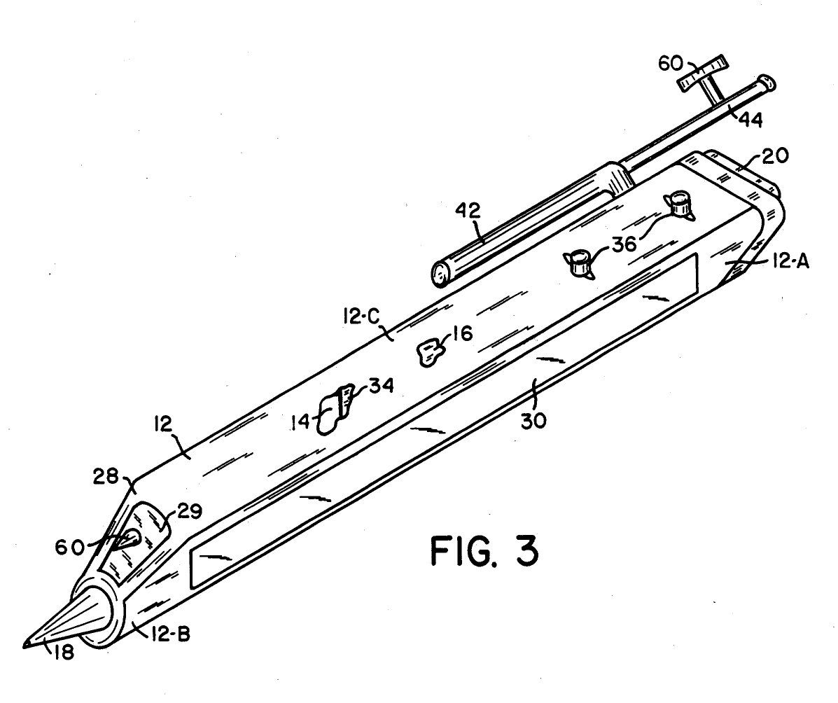

With reference to FIG. 3, the cell phone as depicted therein provides a different example of a suitable communication means, wherein the cell phone electrical components (16) further include known circuitry that allows the cell phone to be activated via voice recognition and/or voice activation. In this type of embodiment, the cell phone electrical components (16) further include appropriate circuitry for interaction with a wireless carrying box, (not shown). This type circuitry allows for wireless communications from satellite phone to separate speakers. As previously noted, these types of electronics can easily be contained within an object to be worn by the user, such as earrings, eye glass frames, head phones, or even within or attached onto a hearing aid, or the like.

With further reference to FIG. 3, internal compartment (14) also contains a vibration device (34). Whereby, housing (12) automatically vibrates when the cell phone receives an incoming call. It is to be noted that within this embodiment, the cell phone electrical components (16) further include voice recognition and/or voice activation. Whereby, the cell phone can be automatically activated by an on/off two-position switch button (36), and/or the cell phone options such as dialing can be programmed for actuation upon receiving simple audible voice commands. Furthermore, within this embodiment the data viewing screen (30) can be elongated so as to allow for a larger viewing area. This is an important factor as this allows for more advertising if so desired.

With still further reference to FIG. 3, within this embodiment it is to be noted that housing (12) may further include known circuitry typically associated with palm-pilots. Thus as an added feature the elongated data viewing screen (30) is very advantageous as this allows a user to input data using an electronic stylus (38), such as typically used with computers, palm-pilots and/or cad programs. Therefore as another convenience, housing (12) also includes a storage receptacle (40) for removal and insertion of an electronic stylus (38). Other optional features may be to include electronics for radio reception that allows the user to listen to music if so desired. Another option may be to include within the electronics (16) appropriate circuitry such as associated with a calculator, or the like. Still another alternative may be to include appropriate electrical circuitry and/or software so as to allow the user to send and receive e-mail, etc.

Yet another option for the present invention may be to further include on the cell phone, or either on the antenna (44) or onto pen clip (42), a satellite ear receptor dish (60) if so desired. This is very advantageous as it serves to provide increased reception and is of a size and shape to be comfortably positioned within or next to the users ear. The dish (60) can be used with either the right or left ear and it also may be adjustable so as to vary the length thereof and this is very important as every user has different needs for comfort, etc.

Other options may be to include circuitry for disabling use of the cell phone or programming means for allowing operation only during specific hours. Thus the cell phone may only be used during the specified time or it may be only functional for receiving a pre-programmed number in case of an emergency, and/or it may only be functional for dialing 911, or for activation upon a voice command such as “nine-one-one.” This may prove to be very important in the near future, as there are currently debates pertaining to use and/or restrictions and regulations for use by students during class.

Again, circuitry for each of the above addressed options, such as the vibration device (34), electronic stylus (38) etc., currently exist and such circuitry is very well known within the art, thus there is no need to provide an explanation as to the exact components and/or function herein. However, it is to be noted electronic stylus (38) is designed so as to either produce an appropriate current and/or receive an appropriate current.

It can now be seen herein taught is a novel, unique cell phone and writing instrument in combination and includes varied options for different embodiments. The device may be voice activated, may include voice recognition, a vibration device, unusual keypad, on/off switch with light, one or two stylus's, etc.

Although the invention has been herein shown and described in what is conceived to be the most practical and preferred embodiment, it is recognized that departures may be made there from within the scope and spirit of the invention, which is not to be limited to the details disclosed herein but is to be accorded the full scope of the claims so as to embrace any and all equivalent devices and apparatuses.

Having described the invention, what I claim as new and desire to secure by Letters Patent is:

1. A cell phone and writing instrument in combination comprising: a housing which is of a shape and size comparable to a writing implement, said housing having a top end, a bottom end, and an elongated body section, said housing having an internal compartment for containment of cell phone electrical components and a writing stylus therein, and said writing stylus protruding from said bottom end when in a writing mode.

2. The cell phone and writing instrument in combination of claim 1, wherein said top end includes an on/off switch mechanism.

3. The cell phone and writing instrument in combination of claim 2 wherein said on/off switch mechanism further includes a light,
whereby:
said light illuminates and/or flashes when said cell phone receives an incoming call.

4. The cell phone and writing instrument in combination of claim 1 wherein said bottom end further includes an angled cutout section so as to allow a user to visually see said writing stylus while writing.

5. The cell phone and writing instrument in combination of claim 1 wherein said internal compartment further contains a vibration device,
whereby:
said housing automatically vibrates when said cell phone receives an incoming call.

6. The cell phone and writing instrument in combination of claim 1 wherein said cell phone electrical components include voice recognition and/or voice actuation.

7. The cell phone and writing instrument in combination of claim 1 wherein said housing further includes a data viewing screen for display of messages and/or numbers there through.

8. The cell phone and writing instrument in combination of claim 1 wherein said housing further includes a fixedly attached pen clip thereon which functions as an antenna.

9. The cell phone and writing instrument in combination of claim 8 wherein said pen clip contains a telescopic antenna therein.

10. The cell phone and writing instrument in combination of claim 1 wherein said housing includes an open access compartment for removal and containment of an electric stylus therein.

11. The cell phone and writing instrument in combination of claim 1 wherein said writing stylus is in the form of a pencil.

12. The cell phone and writing instrument in combination of claim 1 wherein said writing stylus is in the form of an ink pen.

13. The cell phone and writing instrument in combination of claim 1 wherein said writing stylus is replaceable and/or refillable.

14. The cell phone and writing instrument in combination of claim 1 wherein said elongated body section includes multiple activation buttons thereon.

15. The cell phone and writing instrument in combination of claim 14 wherein said multiple activation buttons protrude outwardly from within said elongated body section.

16. The cell phone and writing instrument in combination of claim 14 wherein said multiple activation buttons are each of the two-position type.

17. The cell phone and writing instrument in combination of claim 16 wherein said multiple activation buttons number at least five comprising: a first button; a second button; a third button; a fourth button; and a fifth button; said first button when activated registers either numeral (1) or (2), said second button when activated registers either numeral (3) or (4), said third button when activated registers either numeral (5) or (6), said fourth button when activated registers either numeral (7) or (8), and said fifth button when activated registers either numeral (9) or (0).

18. The cell phone and writing instrument in combination of claim 17 wherein said multiple activation buttons include at least one additional button, and said additional button when activated does not register a numeral but initiates a programmable response.

19. The cell phone and writing instrument in combination of claim 18 wherein said programmable response includes automatic activation for recording numerals and/or messages when writing with said writing stylus.

20. The cell phone and writing instrument in combination of claim 18 wherein said programmable response includes disabling use of said cell phone, so as to allow operation of said cell phone only during specific hours.

21. The cell phone and writing instrument in combination of claim 18 wherein said programmable response further includes said cell phone only being functional for receiving a pre-programmed number in case of an emergency, and/or said cell phone is only functional for dialing 911.

22. The cell phone and writing instrument in combination of claim 1 wherein said cell phone includes a satellite ear receptor dish.
